(19) United States
(12) Patent Application Publication
(10) Pub. No.: US 2026/0286021 A1
(43) Pub. Date: Sep. 24, 2026

(54) PHOSPHORIC ACID ESTER COMPOSITIONS FOR FLAME-RETARDANT SOFT PVC WITH LOW VOLATILITY

(71) Applicant: LANXESS Deutschland GmbH, Cologne (DE)

(72) Inventors: Lukas Omann, Cologne (DE); Otto Mauerer, Leichlingen (DE); Jan-Gerd Hansel, Bergisch Gladbach (DE)

(73) Assignee: LANXESS Deutschland GmbH, Cologne (DE)

(21) Appl. No.: 19/162,697

(22) PCT Filed: Mar. 4, 2024
(86) PCT No.: PCT/EP2024/055544

§ 371 Date: Sep. 5, 2025

(30) Foreign Application Priority Data
Mar. 15, 2023 (EP) 23162070.9

(51) Int. Cl. C08F 14/06; C08K 5/523

(52) U.S. Cl. CPC C08F 14/06; C08K 5/523

(57) ABSTRACT

Mixtures comprising:
a) 0% to 30% by weight of (RO)₃P═O,
b) 10% to 90% by weight of (RO)₂(PhO)P═O,
c) 10% to 90% by weight of (RO)(PhO)₂P═O and
d) 0% to 0.5% by weight of (PhO)₃P═O
   in each case based on the total weight of components a) to d), in which R is the radical

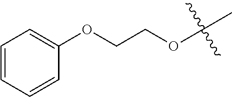 [SMILES: *OCCOc1ccccc1]

and Ph corresponds to the phenyl radical, exhibit a unique combination of low volatility, high flame retardancy and low melting or softening temperature. They are therefore particularly suitable for use as flame retardants in PVC compounds, as hydraulic fluid, as lubricant additive or as additive for paints, adhesives, sealants or coatings.

Phosphoric acid esters can be used in various technical applications, for example as lubricants (cf. U.S. Pat. No. 10,414,964 B2), hydraulic fluids (cf. U.S. Pat. No. 6,703,355 B2), plasticizers (cf. DE 1 768 076) or as flame retardants (cf. U.S. Pat. No. 8,129,457 B2).

The flame-retardant effect of phosphoric acid esters has already been demonstrated in various plastics, for example in PVC (cf. GB 2 302 543 A), in polyolefins (cf. U.S. Pat. No. 11,008,440 B2), in cellulose esters (U.S. Pat. No. 9,000,148 B2), in polyurethanes (cf. U.S. Pat. No. 8,129,457 B2) or in styrene polymers (cf. U.S. Pat. No. 8,026,303 B2).

Phosphoric acid esters are particularly important in the processing of soft PVC, where they act as both flame retardants and plasticizers. Mixed phosphoric acid alkyl aryl esters are often used here. An example is the phosphoric acid 2-ethylhexyl-diphenyl ester known from EP 0 000 240 A1, which is marketed as Disflamoll® DPO.

However, a disadvantage of mixed phosphoric acid alkyl aryl esters is their lower flame-retardant effect and higher volatility in comparison with phosphoric acid triaryl esters. The latter causes a loss of plasticizer and thus undesirable gradual embrittlement over the lifetime of a soft PVC article.

Furthermore, the phosphoric acid alkyl aryl esters from the prior art, such as Disflamoll® DPO, comprise 1% to 5% by weight of triphenyl phosphate. The hazardous substance properties thereof have led to the demand for ever lower contents of this substance in consumer applications.

There has therefore been no lack of attempts to find improved phosphoric acid alkyl aryl esters. By way of example, phosphoric acid esters based on 2-phenoxyethanol and phenol are known from R. T. Gottesman et al., Fire Retardants, Proc. Int. Symp. Flammability Fire Retardants 1976, 225-237. The products are described as phosphoric acid ester compositions, but their constituents or their quantity ratios are not disclosed. There is also no information about the content of triphenyl phosphate or the volatility of the products.

When reworking the preparation of phosphoric acid esters based on 2-phenoxyethanol and phenol according to Gottesman et al., it was found that a high content of triphenyl phosphate occurs and the volatility is in need of improvement.

The object of the present invention was therefore to provide a mixture which features low volatility and a low content of triphenyl phosphate and in particular in compositions with PVC moulding compounds achieves a high flame-retardant effect. Preferably, this mixture should have a low melting point and ideally be present in liquid form at room temperature, which facilitates the processing. Preferably, this mixture should also be obtainable by a less complex process and with a low content of triphenyl phosphate. In addition, a plasticizing effect in PVC should be achieved.

The object is achieved by mixtures comprising:
a) 0% to 30% by weight of (RO)₃P═O,
b) 10% to 90% by weight of (RO)₂(PhO)P═O,
c) 10% to 90% by weight of (RO)(PhO)₂P═O and
d) 0% to 0.5% by weight of (PhO)₃P═O
   in each case based on the total weight of components a) to d), preferably in each case based on the total weight of the mixture,
   in which R is the radical

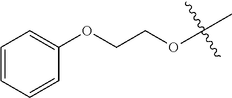 [SMILES: *OCCOc1ccccc1]

and Ph corresponds to the phenyl radical.

In a preferred embodiment of the invention, the mixture comprises
a) 1% to 30% by weight of (RO)₃P═O,
b) 20% to 84% by weight of (RO)₂(PhO)P═O,
c) 15% to 79% by weight of (RO)(PhO)₂P═O and
d) 0% to 0.5% by weight of (PhO)₃P═O
   in each case based on the total weight of components a) to d), preferably in each case based on the total weight of the mixture.

In a further preferred embodiment of the invention, the mixture comprises
a) 5% to 30% by weight of (RO)₃P═O,
b) 20% to 80% by weight of (RO)₂(PhO)P═O,
c) 15% to 75% by weight of (RO)(PhO)₂P═O and
d) 0% to 0.2% by weight of (PhO)₃P═O
   in each case based on the total weight of components a) to d), preferably in each case based on the total weight of the mixture.

In a further preferred embodiment of the invention, the mixture comprises
a) 10% to 25% by weight of (RO)₃P═O,
b) 50% to 75% by weight of (RO)₂(PhO)P═O,
c) 15% to 40% by weight of (RO)(PhO)₂P═O and
d) 0% to 0.2% by weight of (PhO)₃P═O
   in each case based on the total weight of components a) to d), preferably in each case based on the total weight of the mixture.

In a particularly preferred embodiment of the invention, the phosphoric acid ester composition according to the invention comprises less than 0.2% by weight of triphenyl phosphate, particularly preferably less than 0.1% by weight of triphenyl phosphate.

Preferably, the mixtures according to the invention are present as solids or as a liquid at 23° C. and 1013 mbar, particularly preferably as a liquid with a dynamic viscosity of 20 to 5000 mPa-s, most preferably of 50 to 2000 mPa-s (in each case at 23° C.).

Preferably, the mixtures according to the invention have a melting or softening point of below 70° C., preferably of below 55° C., particularly preferably of below 40° C.

Preferably, the mixtures according to the invention have an acid value of less than 5 mg KOH/g, preferably less than 1 mg KOH/g, particularly preferably less than 0.3 mg KOH/g, very preferably less than 0.1 mg KOH/g.

It has surprisingly been found that PVC moulding compounds comprising the mixtures according to the invention have high flame retardancy. The mixtures according to the invention can be prepared unexpectedly easily in a novel process in such a way that the mixture contains no or only very little triphenyl phosphate.

The invention further provides a process for preparing the mixtures according to the invention, comprising the steps of:
(a) provision of a mixture comprising phosphorus oxychloride and phenoxyethanol,
(b) reaction of at least part of the mixture from a) at temperatures between 0° C. and 50° C. with removal of hydrogen chloride,
(c) provision of a mixture comprising phenol and a base, and optionally a solvent,
(d) combination of the mixture obtained from b) and the mixture from c) and reaction at temperatures between −20° C. and 50° C. to form a chloride salt.

In an alternative embodiment, at least part of the phosphorus oxychloride is metered in only in step b). It is also possible for at least part of the phenoxyethanol to be metered in only in step b).

The reaction according to step b) is usually performed in the range from 0° C. to 50° C., preferably in the range from 10° C. to 40° C., particularly preferably in the range from 20° C. to 30° C.

Optionally, a distillative removal of (unreacted) reactants from step a) and/or formed byproducts (such as hydrogen chloride) may be performed between step b) and step c). The distillation may be carried out as a batch process or as a continuous process. The temperature of the distillation is preferably in the range from 0° C. to 50° C. Particularly preferably, the distillation is carried out at the reaction temperature of step b) or a temperature between 0° C. and the reaction temperature of step b). The distillation is performed in a pressure range from 0.01 mbar to 1013 mbar, preferably in the range from 0.01 mbar to 100 mbar, very particularly preferably in the range from 0.01 mbar to 50 mbar.

All commercially available bases known to those skilled in the art may be used as base for step c). These include alkali metal hydroxides such as NaOH, KOH or LiOH, or amines such as triethylamine, imidazole, 1-methylimidazole, diisopropylethylamine, dibutylamine, morpholine, etc., including ammonia or ammoniacal solutions.

In a preferred embodiment, a solvent is used for the reaction in step c). All commercially available solvents known to those skilled in the art may be used as solvent. These include for example water, aromatic hydrocarbons, such as toluene, xylene, aliphatic hydrocarbons, such as pentane, hexane, cyclohexane, heptane or longer-chain hydrocarbons, or chlorinated hydrocarbons, such as dichloromethane, dichloroethane or chlorobenzene.

In an alternative embodiment, at least part of the mixture provided in step c) is metered into the mixture obtained in step b). It is also possible for at least part of the base or part of the phenol to be metered in only in step d).

The reaction according to step d) is usually performed in the range from −20° C. to 50° C., preferably in the range from 0° C. to 30° C.

A removal of reactants and/or of byproducts from steps b) and/or d) may be performed after step d), by means of filtration, extraction, washing and/or distillation. In a preferred embodiment of the invention, the chloride salts formed as coproduct are first removed. If water was used as optional solvent in step c), the removal can be performed by simply separating the aqueous and organic phases. If step c) was carried out without water, the chloride salts can be removed by filtration.

For further purification, the product may be subjected to washing. Suitable washing solutions are for example sodium hydroxide solution or potassium hydroxide solution or water. The washing is usually performed at temperatures between 20° C. and 50° C.

The solvent optionally used in step c) can be removed by distillation. The conditions of the distillation can be easily determined by those skilled in the art.

Depending on the application, the mixtures according to the invention may also comprise further auxiliaries. Examples of suitable auxiliaries are plasticizers, plasticizing polymers, polymer modifiers, stabilizers (for example thermal stabilizers, light stabilizers, antioxidants), co-stabilizers (for example acid scavengers, free-radical scavengers), internal and external lubricants, viscosity regulators, fillers, colour pigments, dyes, flame retardants, flame retardant synergists, blowing agents and further functional additives such as antistatic agents, nucleating agents, UV protection agents or biocides (see for example R. D. Maier, M. Schiller, Handbuch Kunststoff-Additive [Plastics Additives Handbook], 4th edition, Munich, Carl Hanser Verlag, 2016, p. 513 ff.).

The mixtures according to the invention are suitable as flame retardants. The present invention thus further provides for the use of the mixtures according to the invention as flame retardants.

The mixtures according to the invention can be used as flame retardants in all applications for flame retardants that are known to those skilled in the art. Preferably, the mixtures according to the invention are used as flame retardants for
synthetic polymers, such as polyolefins, polyvinyl chloride, polycarbonates, styrene-based (co)polymers, polyamides, polyesters, polyurethanes, elastomers such as NBR, CR, SBR, or EPDM and thermosets such as epoxy resins, unsaturated polyester resins and phenol formaldehyde resins,
materials of plant origin, such as wood, wood-plastic composites, paper and cardboard, and
materials of animal origin, such as leather.

Particular preference is given to using the mixtures according to the invention as flame retardants for polyvinyl chloride (PVC), for example in PVC moulding compounds, i.e. in compositions comprising PVC which are in the form of granules, a powder, a paste or a plastisol.

The invention therefore also provides compositions preferably in the form of granules, a powder, a paste or a plastisol, comprising a mixture according to the invention and polyvinyl chloride (PVC). These PVC moulding compounds according to the invention are preferably soft PVC. The PVC moulding compounds according to the invention can be produced by mixing and compounding PVC with the mixtures according to the invention and optionally further auxiliaries, e.g. stabilizers, in a known manner (see for example G. Becker, D. Braun, Kunststoff-Handbuch, Polyvinylchlorid [Plastics Handbook, Polyvinyl Chloride], Vol. 2/2, Munich, Vienna, Carl Hanser Verlag, 1986, p. 829 ff.) or dispersing it to form a ready-to-process plastisol or organosol.

The PVC moulding compound according to the invention preferably comprises 5 to 150 parts by weight, particularly preferably 30 to 70 parts by weight of phosphoric acid esters according to the invention (RO)₃P═O, (RO)₂(PhO)P═O, (RO)(PhO)₂P═O and (PhO)₃P═O as defined above based on 100 parts by weight of PVC. In a preferred embodiment, the PVC moulding compound according to the invention comprises 5 to 150 parts by weight, particularly preferably 30 to 70 parts by weight of phosphoric acid esters according to the invention based on 100 parts by weight of PVC.

The PVC moulding compound according to the invention can be used in coatings, films, cables, pipelines, hoses, seals, conveyor belts, roofing membranes, adhesive tape films, tarpaulins, awnings and tents.

The invention further provides for the use of the mixtures according to the invention in hydraulic fluids or for the production of hydraulic fluids. Preferably, the mixtures according to the invention are used in flame-retardant hydraulic fluids.

The invention further provides for the use of the mixtures according to the invention as lubricant additive. Preferably, the mixtures according to the invention are used in flame-retardant lubricants.

The invention further provides for the use of the mixtures according to the invention as additive for paints, adhesives, sealants and coatings.

The invention further provides for the use of the mixtures according to the invention as heat transfer medium or in preparations that are used as heat transfer medium. Preferably, the mixtures according to the invention are used as heat transfer medium or in heat transfer medium preparations in the immersion cooling of electrical components. In addition to the mixtures according to the invention, the heat transfer medium preparations for example comprise further trialkyl phosphates, triaryl phosphates, mineral oils, polyalphaolefins, esters, antioxidants, metal deactivators, flow additives, corrosion inhibitors, foam inhibitors, demulsifiers and/or pour point depressants.

### EXAMPLES

### Determination of the Composition of the Phosphoric Acid Ester Compositions

Quantitative GC-FID analysis was carried out using an Agilent 7890A GC instrument equipped with a CB-Sil 5 CB quartz capillary column (length: 30 m, diameter: 0.32 mm, film thickness: 3.00 μm). The carrier gas used was hydrogen. The sample (dissolved in acetone) was injected in split mode (86:1) at a temperature of 300° C. The following temperature program was set: 60° C. start temperature, heating rate 10° C./min to a temperature of 150° C., then at a heating rate of 25° C./min to 280° C., hold time: 10 min, then at a heating rate of 25° C./min to a final temperature of 320° C./min, hold time: 10 min. The evaluation was performed by integration of the corresponding baseline-separated signal and conversion of the peak areas into a content after prior calibration.

### Determination of the Viscosity of the Phosphoric Acid Ester Compositions

The dynamic viscosity of phosphoric acid esters was measured using an Anton Paar MCR 102 shear rheometer at the specified temperature with a shear rate of 200 s⁻¹ in accordance with DIN 53018.

### Determination of the Acid Value of the Phosphoric Acid Ester Compositions

The acid value of the samples was determined in accordance with DIN EN ISO 2114 (Method B, colorimetric titration with phenolphthalein). To this end, the sample (10 g) was weighed, dissolved in acetone (200 ml) and water (50 ml) and admixed with 2-3 drops of a phenolphthalein solution (0.1% by weight in ethanol/water (v/v=4/1)). Sodium hydroxide solution (0.1 mol/l) was titrated from a burette until the colour change from colourless to pink remained for at least 10 seconds with stirring. A blank value was measured in the same way but without a sample.

### SYNTHESIS EXAMPLES

### Comparative Example 1 (V1)

Preparation in accordance with R. T. Gottesman et al., Fire Retardants, Proc. Int. Symp. Flammability Fire Retardants 1976, 225-237:

Phosphorus oxychloride (200 parts by weight) was initially charged into a reactor with stirrer, internal thermometer, nitrogen inlet and reflux condenser. Phenoxyethanol (182 parts by weight) was metered in. The thus obtained reaction product was reacted with a solution of sodium hydroxide (129 parts by weight), phenol (245 parts by weight) and water (600 parts by weight), resulting in a two-phase reaction mixture. After separating the phases, the organic phase was washed with sodium hydroxide solution (0.5 mol/l; 500 parts by weight) and then with water (500 parts by weight). Volatile components were removed by distillation at 50° C. and 20 mbar. The product mixture was isolated as a solid (melting point: 73° C.). The acid value was 0.1 mg KOH/g. The phosphoric acid ester composition was 0.5% by weight (phenoxyethylO)₃P═O, 13.7% by weight (phenoxyethylO)₂(PhO)P═O, 84.8% by weight (phenoxyethylO)(PhO)₂P═O and 1.0% by weight (PhO)₃P═O (“TPP”).

### Synthesis Example 1 (S1) According to the Invention

Phosphorus oxychloride (200 parts by weight) was initially charged into a reactor with stirrer, internal thermometer, nitrogen inlet and reflux condenser. Phenoxyethanol (271 parts by weight) was metered in in such a way that the internal temperature was kept between 20° C. and 25° C. After addition was complete, the pressure in the apparatus was reduced stepwise from atmospheric pressure to 10 mbar and kept under final conditions for 1 h. The reaction mixture was metered at 0° C. into a mixture of dichloromethane (401 parts by weight), phenol (210 parts by weight) and triethylamine (251 parts by weight), with the internal temperature kept between 0° C. and 15° C. The solids were filtered off, and the filtrate was washed three times with sodium hydroxide solution (2%, 500 parts by weight) and three times with water (500 parts by weight). The solvent was removed by distillation at 90° C. and 20 mbar. The product mixture was isolated as a solid (melting point: 54° C.). The acid value was <0.1 mg KOH/g. The product mixture contained 5.3% by weight of (phenoxyethylO)₃P═O, 43.1% by weight of (phenoxyethylO)₂(PhO)P═O, 51.6% by weight of (phenoxyethylO)(PhO)₂P═O and <0.1% by weight of (PhO)₃P═O (“TPP”).

### Synthesis Example 2 (S2) According to the Invention

Phosphorus oxychloride (201 parts by weight) was initially charged into a reactor with stirrer, internal thermometer, nitrogen inlet and reflux condenser. Phenoxyethanol (361 parts by weight) was metered in in such a way that the internal temperature was kept between 20° C. and 25° C. After addition was complete, the pressure in the apparatus was reduced stepwise from atmospheric pressure to 10 mbar and kept under final conditions for 1 h. The reaction mixture was metered at 0° C. into a mixture of dichloromethane (401 parts by weight), phenol (186 parts by weight) and triethylamine (222 parts by weight), with the internal temperature kept between 0° C. and 15° C. The solids were filtered off, and the filtrate was washed three times with sodium hydroxide solution (2%, 500 parts by weight) and three times with water (500 parts by weight). The solvent was removed by distillation at 90° C. and 20 mbar. The product mixture was isolated as a viscous liquid (330 mPa-s at 23° C.). The acid value was <0.1 mg KOH/g. The product mixture contained 20.8% by weight of (phenoxyethylO)₃P═O, 58.9% by weight of (phenoxyethylO)₂(PhO)P═O, 20.3% by weight of (phenoxyethylO)(PhO)₂P═O and <0.1% by weight of (PhO)₃P═O (“TPP”).

TABLE 1
Use amounts and analytical data for
Synthesis Examples V1, S1 and S2.

| | Example | V1 | S1 | S2 |
|---|---|---|---|---|
| Weights | Phosphorus oxychloride | 200 | 200 | 201 |
| [parts by | Phenoxyethanol | 182 | 271 | 361 |
| weight] | Phenol | 245 | 210 | 186 |
| Composition | (PhenoxyethylO)₃PO | 0.5 | 5.3 | 20.8 |
| [% by | (PhenoxyethylO)₂(PhO)PO | 13.7 | 43.1 | 58.9 |
| weight] | (PhenoxyethylO)(PhO)₂PO | 84.8 | 51.6 | 20.3 |
| | (PhO)₃PO (“TPP”) | 1.0 | <0.1 | <0.1 |
| Analysis | Viscosity at 23° C. [mPa · s] | — | — | 330 |
| | Melting point [° C.] | 73 | 54 | — |
| | Acid value [mg KOH/g] | 0.1 | <0.1 | <0.1 |

### Production of Soft PVC

The soft-PVC moulding compounds used for the testing were produced on a laboratory rolling mill. After the mixture of all formulation constituents (see Table 2) has been added, it is left on the roller until a sheet has formed. From the point in time at which the sheet forms, the compounds were compounded for a further 10 minutes on the rolling mill and finally removed as a rolled sheet. The rolling temperature was 165° C.

The test specimens for determining the LOI were produced from the rolled sheets using a press. The pressing temperature was 170° C.; the pressing duration was 4 minutes for preheating at low pressure (<10 bar) and 2 minutes at high pressure (>100 bar). Test specimens with dimensions of 90×13×4 mm were sawn from the 4 mm-thick pressed plates.

The test specimens for determining the hardness of the compounds (50×40×6 mm) are pressed for longer at the same temperature due to the large thickness of 6 mm. The pressing duration was 7 minutes for preheating at low pressure and 3 minutes for compression moulding at high pressure.

TABLE 2
Formulation constituents for the production of soft PVC.

| | | | Amount |
|---|---|---|---|
| Component | Function | Description | (parts by weight) |
| A | PVC | Vinnol S4170 | 100 |
| B | Co-stabilizer | Drapex 39 | 2.5 |
| C | PVC stabilizer | Bärostab UBZ 780 RF | 2.5 |
| D | Flame retardant | As shown in Table 3 | 55 |

The production of soft PVC was successful with all phosphoric acid ester preparations according to the invention. All samples were readily processable.

### Determination of Flame Retardancy, Plasticizing Effect and Volatility

The limiting oxygen index (=LOI) was used for the assessment of flame retardancy. The LOI is a measure of the burning behaviour of plastics and other materials. The LOI is the minimum oxygen concentration of a nitrogen/oxygen mixture under which the combustion of a test specimen under standardized conditions can just take place. The test was carried out in accordance with ISO 4589-2.

The plasticizing effect of the phosphoric acid esters was determined using a Shore A hardness measurement of the phosphoric acid ester-containing soft-PVC compounds. The measurement principle is based on the penetration depth of a metal test pin into the material sample for 15 s with a force of 12.5N. The Shore A hardness was determined for test specimens with dimensions of 50×40×6 mm. The Shore hardness measurement was performed in accordance with DIN ISO 7619-1. A Shore A hardness of less than 95 is to be considered as an indicator of a plasticizing effect.

The volatility of the plasticizer was determined by thermogravimetric analysis (TGA) on a Mettler Toledo TGA/DSC 3+ instrument. Here, the mass change was determined by evaporation of a sample depending on temperature and time. The individual samples (<20 mg) were weighed out in an open porcelain crucible and heated from room temperature to 500° C. at a constant heating rate of 10 K/min under nitrogen. The mass losses of the individual products were determined at 245° C.

The results of the measurements are compiled in Table 3.

TABLE 3
Determination of the flame retardancy of the PVC specimens produced
and the volatility of the flame retardants used therefor.

| Exam- | Flame retardant | Shore A | | Weight loss at |
|---|---|---|---|---|
| ple | (Component D) | hardness < 95 | LOI | 245° C. (TGA) |
| 1 | Disflamoll ® DPO | + | 27.4 | 29.9% by weight |
| 2 | V1 | + | 29.0 | 6.0% by weight |
| 3 | S1 | + | 29.1 | 5.5% by weight |
| 4 | S2 | + | 29.0 | 3.6% by weight |

The results surprisingly show that the phosphoric acid ester preparations according to the invention have a significantly lower volatility than the comparative example Disflamoll® DPO.

1. A mixture comprising:
a) 0% to 30% by weight of (RO)₃P═O;
b) 10% to 90% by weight of (RO)₂(PhO)P═O;
c) 10% to 90% by weight of (RO)(PhO)₂P═O; and
d) 0% to 0.5% by weight of (PhO)₃P═O,
in each case based on the total weight of components a) to d),
in which R is a radical 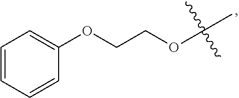 [SMILES: *OCCOc1ccccc1]
and Ph corresponds to a phenyl radical.

2. The mixture according to claim 1 comprising less than 0.2% by weight of triphenyl phosphate.

3. The mixture according to claim 1, wherein the mixture is present as a solid or as a liquid at 23° C. and 1013 mbar.

4. The mixture according to claim 3, wherein the mixture has a melting or softening point of below 70° C.

5. A process for preparing a mixture according to claim 1, comprising the steps of:
(a) providing a mixture comprising phosphorus oxychloride and phenoxyethanol;
(b) reacting at least part of the mixture from a) at temperatures between 0° C. and 50° C. with removal of hydrogen chloride;
(c) providing a mixture comprising phenol and a base, and optionally a solvent; and
(d) combining the mixture obtained from b) and the mixture from c) and reaction at temperatures between −20° C. and 50° C. to form a chloride salt.

6. The process according to claim 5, wherein the base used in step c) is a trialkylamine.

7. The process according to claim 5, wherein a distillative removal of reactants from step a) and/or of byproducts is performed between step b) and step c).

8. The process according to claim 5, wherein a removal of reactants and/or of byproducts from steps b) and/or d) is performed after step d).

9. A flame retardant comprising the mixture according to claim 1.

10. The flame retardant according to claim 9, further comprising polyvinyl chloride (PVC).

11. A moulding compound comprising the mixture according to claim 1 and polyvinyl chloride (PVC).

12. The moulding compound according to claim 11, comprising from 5 to 150 parts by weight of the phosphoric acid esters a) to d) based on 100 parts by weight of PVC.

13. (canceled)

14. A hydraulic fluid comprising the mixture according to claim 1.

15. A lubricant additive comprising the mixture according to claim 1.

16. An additive for paints, adhesives, sealants or coatings comprising the mixture according to claim 1.

17. A heat transfer medium comprising the mixture according to claim 1.
